(19) United States
(12) Patent Application Publication
(10) Pub. No.: US 2026/0319351 A1
(43) Pub. Date: Oct. 15, 2026

(54) SPACE RENDERING APPARATUS AND SPACE RENDERING METHOD

(71) Applicant: NTT, Inc., Tokyo (JP)

(72) Inventors: Takahiro MATSUMOTO, Musashino-shi, Tokyo (JP); Ayaka SANO, Musashino-shi, Tokyo (JP); Motohiro Makiguchi, Musashino-shi, Tokyo (JP)

(21) Appl. No.: 19/100,625

(22) PCT Filed: Aug. 9, 2022
(86) PCT No.: PCT/JP2022/030437

§ 371 Date: Feb. 3, 2025

(51) Int. Cl. G03B 21/604; G02B 27/28; G02B 30/26

(52) U.S. Cl. CPC G03B 21/604; G02B 27/288; G02B 30/26

(57) ABSTRACT

A space production apparatus according to one aspect of the present invention includes a first light source, a second light source, a polarizing mirror, and a first physical surface. The first light source emits first light for projecting a first image. The second light source emits second light for projecting a second image. The polarizing mirror includes a first surface facing an observer area where an observer is expected to be located and a second surface opposite to the first surface and is configured to reflect light polarized in a first direction and transmit light polarized in a second direction orthogonal to the first direction. The first physical surface is disposed on a side of the first surface of the polarizing mirror and is configured to reflect light while maintaining polarization characteristics, and at least the first image is projected onto the first physical surface.

### TECHNICAL FIELD

The present invention relates to a space production apparatus and a space production method.

### BACKGROUND ART

Normally, an image of light reflected in a mirror is literally an image formed by specular reflection on the surface of the mirror. Therefore, to the human eye, the image when looking at real space reflected in a mirror and the image when looking at real space directly are perceived as identical mirror images. Furthermore, since mirrors are widely used in daily life, what kind of image is reflected in a mirror can often be easily predicted by people who are used to looking at mirrors in their daily lives.

NPL 1 discloses a method of displaying an image that does not exist in real space in a mirror. The method disclosed in NPL 1 uses a half mirror and a light-emitting diode (LED) display in combination, and the LED display is physically installed behind the half mirror. In the part where the LED does not emit light, the half mirror reflects the light in real space to create an image, and in the part where the LED emits light, the LED light passes through the half mirror to create an image on the half mirror. Therefore, when viewed from a person standing in front of the half mirror, an image that does not exist in real space is displayed on the half mirror.

However, since it is necessary to install a relatively heavy LED display in a space behind the mirror, the method disclosed in NPL 1 is difficult to implement in cases where the LED display cannot be placed due to spatial constraints.

### CITATION LIST

### Non Patent Literature

[NPL 1] Uchida Hiroki, Ebihara Tadashi, Wakatsuki Naoto, Zempo Keiichi, “ALiSE: Through the Mirrored Space, and What User Interacts with Avatars Naturally,” Association for Computing Machinery, 2021, p. 29-32.

### SUMMARY OF INVENTION

### Technical Problem

An object of the present invention is to provide a space production technique that presents different images to an observer in a real space and a mirror image space (a real space reflected in a mirror).

### Solution to Problem

A space production apparatus according to one aspect of the present invention includes a first light source, a second light source, a polarizing mirror, and a first physical surface. The first light source emits first light for projecting a first image. The second light source emits second light for projecting a second image. The polarizing mirror includes a first surface facing an observer area where an observer is expected to be located and a second surface opposite to the first surface and is configured to reflect light polarized in a first direction and transmit light polarized in a second direction orthogonal to the first direction. The first physical surface is disposed on a side of the first surface of the polarizing mirror and is configured to reflect light while maintaining polarization characteristics, and at least the first image is projected onto the first physical surface.

### Advantageous Effects of Invention

According to the present invention, it is possible to provide a space production technique that presents different images to an observer in a real space and a mirror image space.

### BRIEF DESCRIPTION OF DRAWINGS

FIG. 1 is a diagram showing an example of a configuration of a space production apparatus according to a first embodiment.

FIG. 2 is a diagram illustrating that light from one of polarized light sources shown in FIG. 1 creates a virtual image in an intra-mirror space.

FIG. 3 is a diagram showing an image presented using one of the polarized light sources shown in FIG. 1.

FIG. 4 is a diagram showing an image presented using the other polarized light source shown in FIG. 1.

FIG. 5 is a diagram showing an image on a screen shown in FIG. 1.

FIG. 6 is a diagram showing an image on a polarizing mirror shown in FIG. 1.

FIG. 7 is a diagram showing another example of the configuration of the space production apparatus according to the first embodiment.

FIG. 8 is a diagram illustrating that light from one of polarized light sources shown in FIG. 7 creates a virtual image in an intra-mirror space.

FIG. 9 is a diagram showing an image seen by an observer in the space production apparatus shown in FIG. 8.

FIG. 10 is a diagram showing still another example of the configuration of the space production apparatus according to the first embodiment.

FIG. 11 is a diagram showing an example of a configuration of a space production apparatus according to a second embodiment.

FIG. 12 is a diagram illustrating that light from polarized light sources shown in FIG. 11 does not create a virtual image in an intra-mirror space.

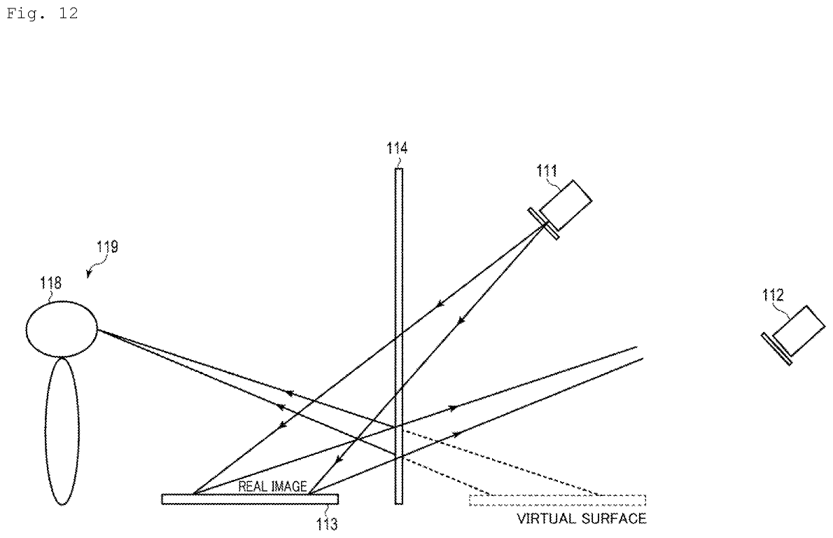

FIG. 13 is a diagram showing an image presented using one of polarized light sources shown in FIG. 11.

FIG. 14 is a diagram showing an image presented using the other polarized light source shown in FIG. 11.

FIG. 15 is a diagram showing an image seen by an observer in the space production apparatus shown in FIG. 11.

FIG. 16 is a diagram showing another example of the configuration of the space production apparatus according to the second embodiment.

### DESCRIPTION OF EMBODIMENTS

Embodiments of the present invention will be described below with reference to the drawings.

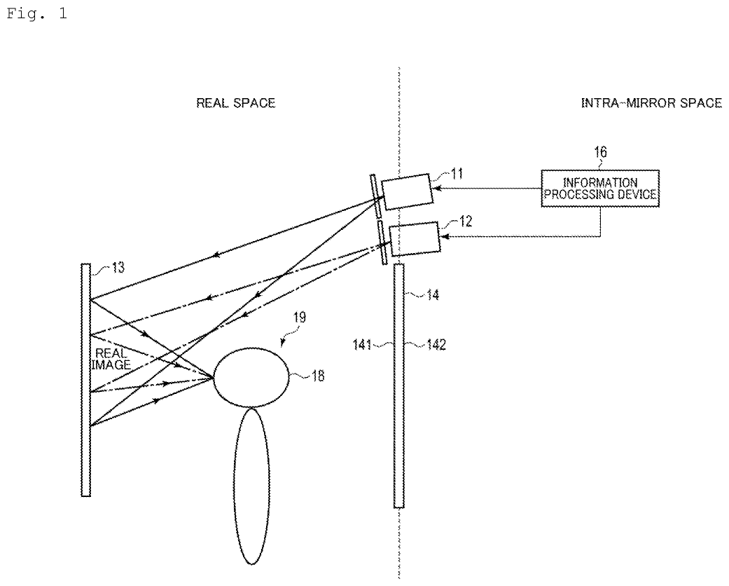

FIG. 1 schematically shows a space production apparatus 10 according to a first embodiment. As shown in FIG. 1, the space production apparatus 10 includes polarized light sources 11 and 12, a screen 13, a polarizing mirror 14, and an information processing device 16.

The information processing device 16 is communicatively connected to the polarized light sources 11 and 12 and controls the polarized light sources 11 and 12. The connection between the information processing device 16 and the polarized light sources 11 and 12 may be a wired connection or a wireless connection. For example, the information processing device 16 controls the polarized light sources 11 and 12 to project an image as visual information. Specifically, the information processing device 16 transmits image data of a first image to be projected to the polarized light source 11, and transmits image data of a second image to be projected to the polarized light source 12. Visual information refers to information that is recognized by people through their sense of sight. The image may be a still image or a moving image (video). The information processing device 16 may be a computer such as a personal computer (PC).

The polarized light sources 11 and 12 are light sources that emit linearly polarized light. Each of the polarized light sources 11 and 12 can be realized, for example, by a combination of a non-polarized light source and a linear polarizer. A non-polarized light source is a light source that emits non-polarized light. As the non-polarized light source, for example, a light projector such as a projector can be used. A projector is an optical device that projects an image onto a surface such as a screen. A linear polarizer is an optical filter that passes light of a specific polarization but blocks light of other polarizations. As the linear polarizer, for example, a linear polarizing film can be used. Linearly polarized light is obtained by passing light from a non-polarized light source through a linear polarizer. The polarized light source 11 emits light polarized in a first direction (for example, vertically) toward the screen 13, and the polarized light source 12 emits light polarized in a second direction (for example, horizontally) orthogonal to the first direction toward the screen 13. The light from the polarized light sources 11 and 12 is directly incident on the screen 13. Hereinafter, the light emitted from the polarized light sources 11 and 12 may be referred to as visual information light.

The polarized light source 11 receives image data of the first image from the information processing device 16 and emits a linearly polarized light beam according to the received image data. The polarized light source 12 receives image data of the second image from the information processing device 16 and emits a linearly polarized light beam according to the received image data. The first image and the second image are projected onto the screen 13.

Note that the information processing device 16 may be omitted from the space production apparatus 10. For example, the functions of the information processing device 16 may be implemented by a computer built into each of the polarized light sources 11 and 12, such as a microcomputer. In this case, the image data may be provided to the polarized light sources 11 and 12 while being stored in a recording medium such as a USB memory.

The screen 13 is a physical surface (for example, a physical plane) which diffusely reflects incident light as linearly polarized light while maintaining its polarization characteristics, and corresponds to a physical surface on which projector light can be projected. A screen that diffusely reflects incident light while maintaining its polarization characteristics is used for stereoscopic viewing using a polarizing filter type three-dimensional (3D) projector. As the screen 13, a silver screen or the like can be used. The screen 13 is placed against a wall opposite an observer area 19 where an observer 18 is expected to be located.

The polarizing mirror 14 selectively transmits light that is linearly polarized in one direction in the vertical and horizontal directions, and reflects light that is linearly polarized in the other direction in the vertical and horizontal directions. As a mirror having optical characteristics corresponding to the polarizing mirror 14, a reflective polarizer such as a wire grid polarizer is known. As the polarizing mirror 14, for example, a beam splitter plate made of a reflective polarizer can be used. Most of the light that exists in our living spaces is unpolarized and is composed of light that has both vertical and horizontal polarization components. A polarizing mirror transmits one of the vertical and horizontal components included in unpolarized light and reflects the other. For this reason, a polarizing mirror placed in a living space is considered as a half mirror, and can reflect the surrounding environment like a mirror.

The screen 13 and the polarizing mirror 14 may be disposed such that the observer 18 located in the observer area 19 can see the screen 13 through the polarizing mirror 14. The polarizing mirror 14 is placed upright facing the observer area 19. The screen 13 and the polarizing mirror 14 are disposed facing each other with the observer area 19 interposed therebetween. The polarizing mirror 14 includes a surface 141 facing the observer area 19 and a surface 142 opposite to the surface 141, and reflects light polarized in the first direction and transmits light polarized in the second direction on each of the surfaces 141 and 142.

In the following, to simplify the description, when the space is divided into two by the polarizing mirror 14, the space on the side where the observer 18 is present is called a real space, and the space behind the polarizing mirror 14 as seen from the observer 18 is called an intra-mirror space.

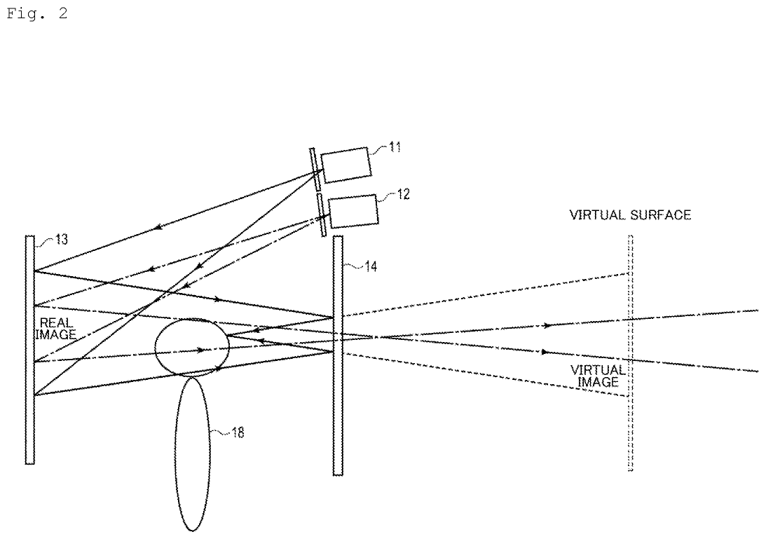

In the space production apparatus 10 having the above structure, the polarized light sources 11 and 12 irradiate the screen 13 with linearly polarized visual information light, thereby creating a real image on the screen 13. The polarized light source 11 emits visual information light that is linearly polarized in a polarization direction reflected by the polarizing mirror 14, and as shown in FIG. 2, the visual information light from the polarized light source 11 is diffusely reflected by the screen 13 while maintaining its polarization characteristics, and then reflected again by the polarizing mirror 14 and reaches the observer 18. Therefore, the visual information light from the polarized light source 11 is observed by the observer 18 as a virtual image in the intra-mirror space. On the other hand, the polarized light source 12 emits visual information light that is linearly polarized in the polarization direction transmitted by the polarizing mirror 14, and the visual information light from the polarized light source 12 is diffusely reflected by the screen 13 while maintaining its polarization characteristics, and then passes through the polarizing mirror 14 and is diffused in the intra-mirror space. Therefore, although the light from the polarized light source 12 appears as a real image on the screen 13, it does not form an image that is recognized by the observer 18 as a virtual image in the intra-mirror space.

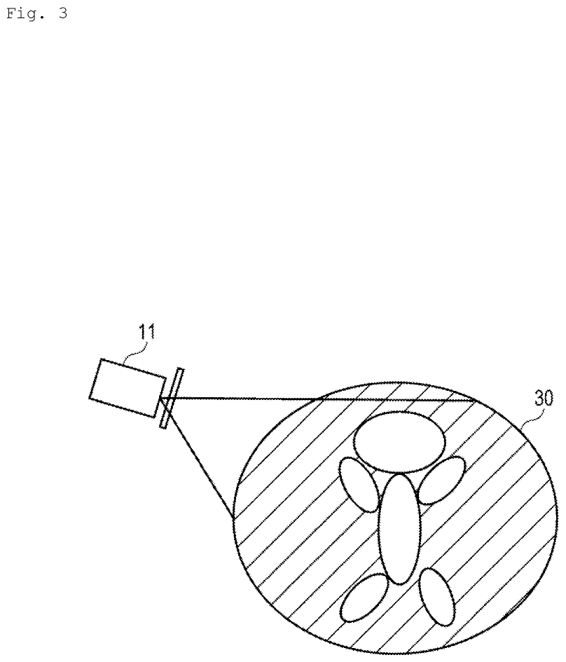

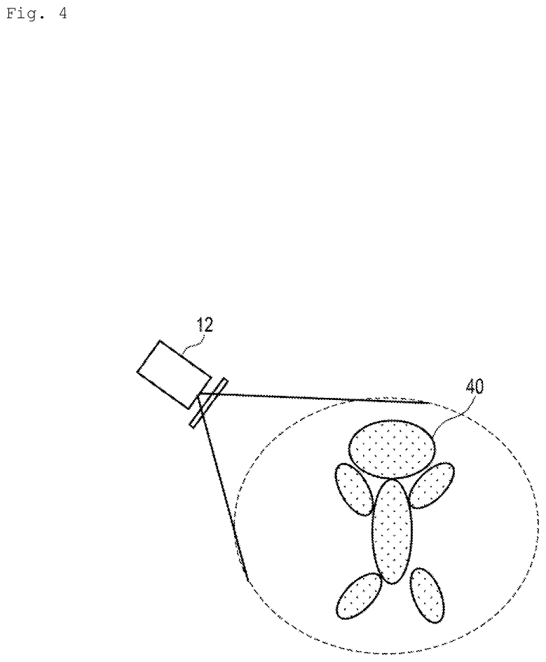

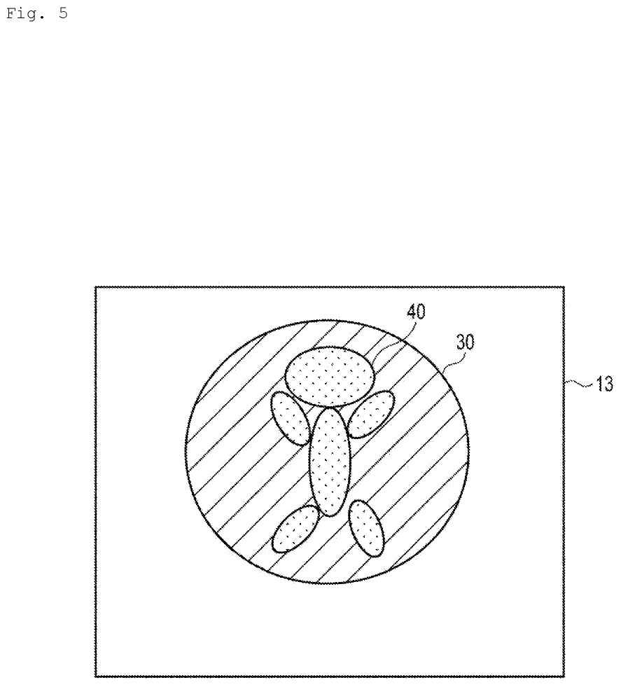

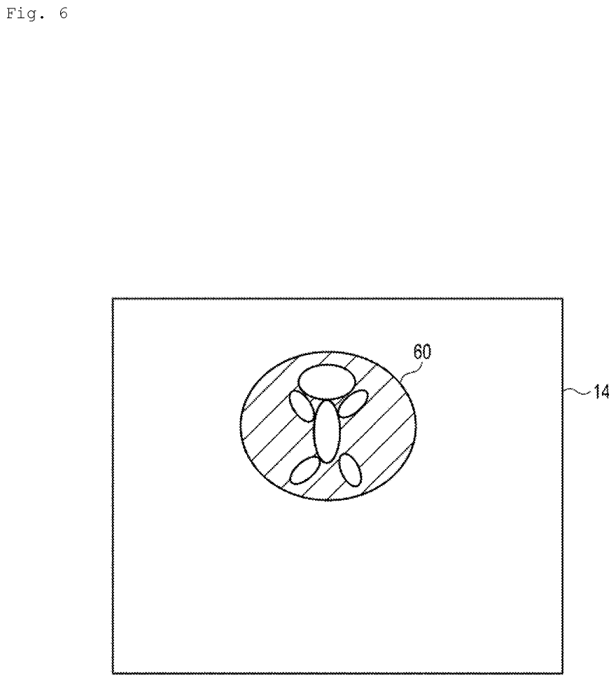

For example, when the polarized light source 11 projects a circular image 30 in the shape of a humanoid shown in FIG. 3, and the polarized light source 12 projects a humanoid image 40 shown in FIG. 4, a combination of the images 30 and 40 is formed on the screen 13, as shown in FIG. 5. For example, when the color of the image 30 and the color of the image 40 are the same, the observer 18 recognizes a circular image on the screen 13. As shown in FIG. 6, an image 60 projected on the polarizing mirror 14 is an image in which the component corresponding to the image 40 is omitted.

As described above, in the space production apparatus 10, the polarized light source 11 emits light that is linearly polarized in the polarization direction reflected by the polarizing mirror 14 toward the screen 13, the polarized light source 12 emits light that is linearly polarized in the polarization direction transmitted by the polarizing mirror 14 toward the screen 13. The light from the polarized light source 11 is diffusely reflected by the screen 13 while maintaining its polarization characteristics, and then reflected by the polarizing mirror 14. Thus, the polarized light source 11 creates a real image on the screen 13 and creates a virtual image on the polarizing mirror 14. On the other hand, the light from the polarized light source 12 is diffusely reflected by the screen 13 while maintaining its polarization characteristics, and then passes through the polarizing mirror 14 and is diffused in the intra-mirror space. Thus, the light from the polarized light source 12 creates a real image on the screen 13, but does not create a virtual image on the polarizing mirror 14. Therefore, the space production apparatus 10 can create a state in which the observer can visually recognize the images derived from the polarized light sources 11 and 12 in the real space (specifically, the screen 13), but cannot visually recognize the image derived from the polarized light source 12 reflected in the mirror (specifically, the polarizing mirror 14). That is, the space production apparatus 10 can present different images to the observer 18 in the real space and the mirror image space (the real space reflected in the mirror). For example, when an image derived from the polarized light source 11 is defined as A and an image derived from the polarized light source 12 is defined as B, the images of A +B can be seen in the real space, and only the image of A can be seen in the intra-mirror space, making it possible to make the image formed by the light illuminating the real space different from the image reflected in the mirror. As a result, it is possible to give the observer 18 an unexpected surprise.

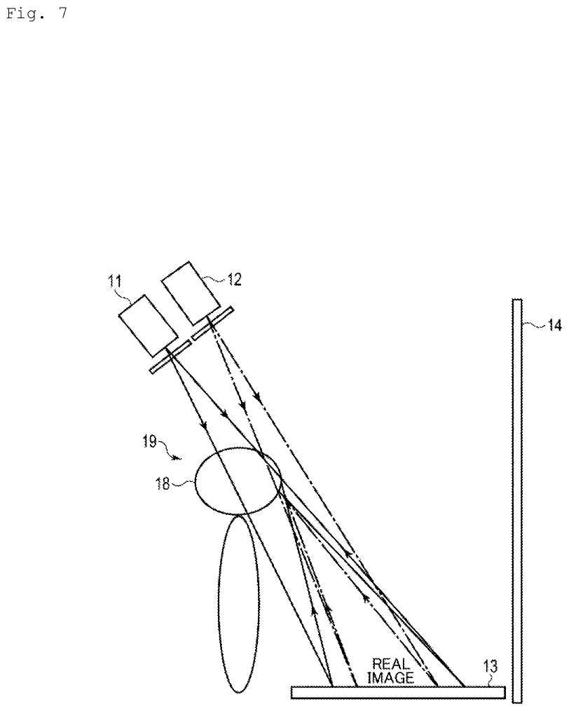

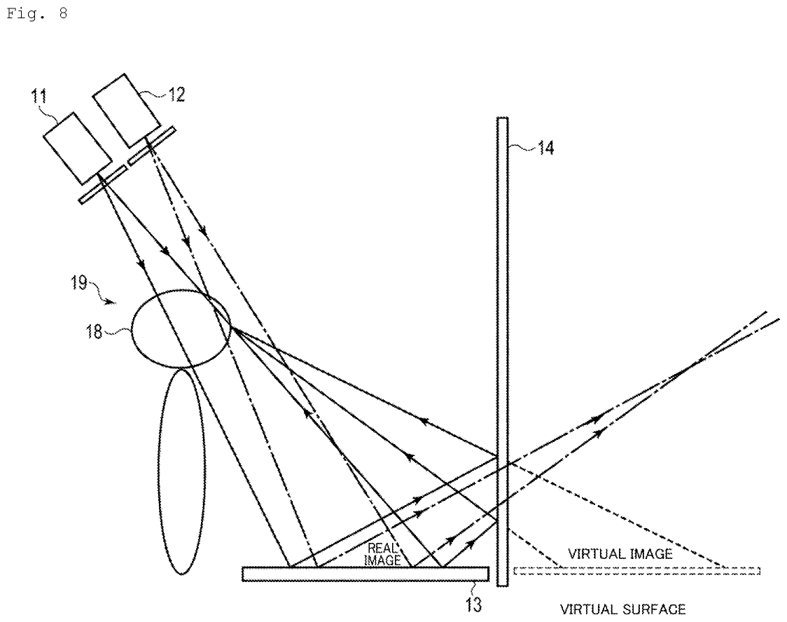

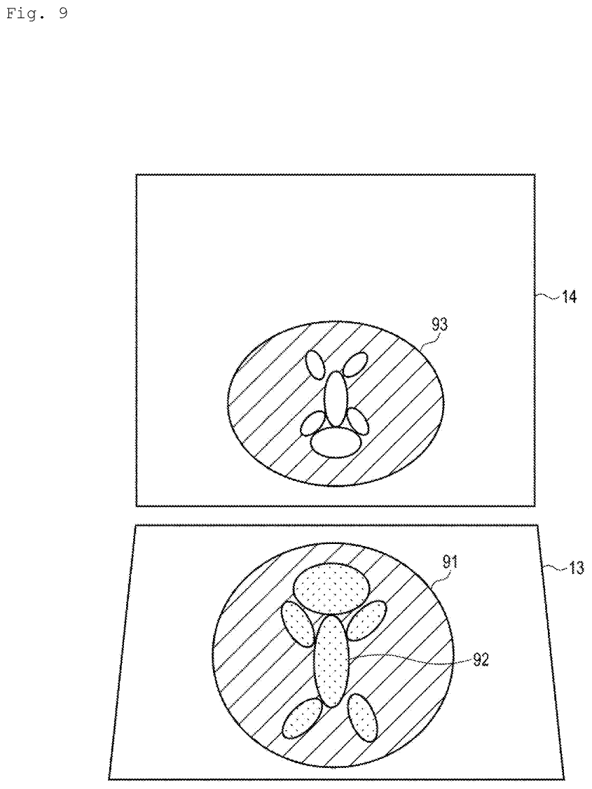

In the above example, the screen 13 is installed at a location facing the polarizing mirror 14. The screen 13 may be installed at another location in the real space, such as at the feet of the observer 18 as shown in FIG. 7. In this case as well, the polarized light sources 11 and 12 irradiate the screen 13 with linearly polarized visual information light, thereby creating real images 91 and 92 on the screen 13 as shown in FIG. 9. As shown in FIG. 8, the visual information light from the polarized light source 11 is diffusely reflected by the screen 13 while maintaining its polarization characteristics, and then reflected again by the polarizing mirror 14 and reaches the observer 18. The visual information light from the polarized light source 12 is diffusely reflected by the screen 13 while maintaining its polarization characteristics, and then passes through the polarizing mirror 14 and is diffused in the intra-mirror space. Therefore, the visual information light from the polarized light source 11 can be observed as a virtual image 93 in the intra-mirror space as shown in FIG. 9, but since the visual information light from the polarized light source 12 does not create a virtual image, the real image on the screen 13 and the virtual image in the intra-mirror space reflected on the polarizing mirror 14 are different images.

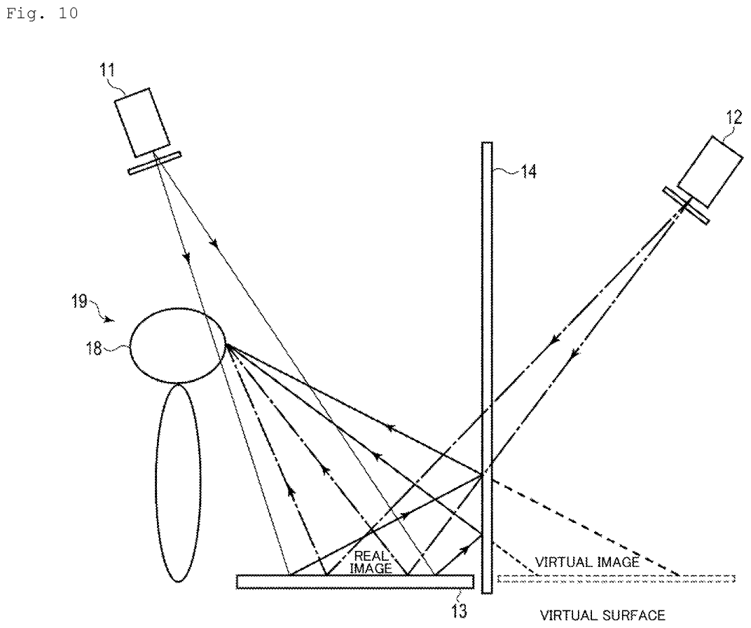

Moreover, it is not necessary to install both the polarized light sources 11 and 12 in the real space, and as shown in FIG. 10, the polarized light source 12 may be installed in the intra-mirror space. In this case, the polarized light source 12 emits visual information light toward the screen 13 via the polarizing mirror 14. Since the polarized light source 12 emits visual information light that is linearly polarized in the polarization direction transmitted by the polarizing mirror 14, the visual information light from the polarized light source 12 passes through the polarizing mirror 14 and reaches the screen 13.

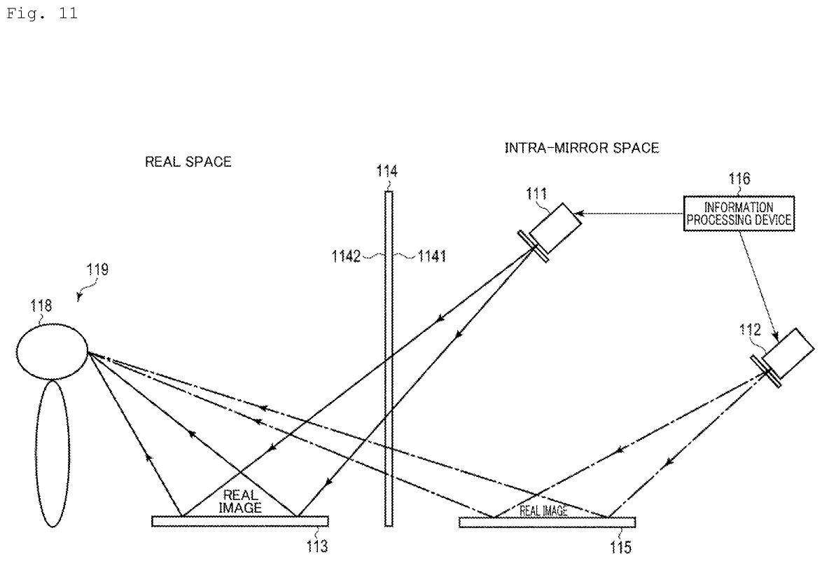

FIG. 11 schematically shows a space production apparatus 110 according to a second embodiment. As shown in FIG. 11, the space production apparatus 110 includes polarized light sources 111 and 112, screens 113 and 115, a polarizing mirror 114, and an information processing device 116. Each of the polarized light sources 111 and 112, the screens 113 and 115, the polarizing mirror 114, and the information processing device 116 have the same configuration as the polarized light sources 11 and 12, the screen 13, the polarizing mirror 14, and the information processing device 16 described in the first embodiment. Therefore, duplicate descriptions will be omitted as appropriate.

The polarizing mirror 114 is placed upright facing an observer area 119 where an observer 118 is expected to be located. The polarizing mirror 114 includes a surface 1141 facing the observer area 119 and a surface 1142 opposite to the surface 1141, and transmits light linearly polarized in a first direction and reflects light linearly polarized in a second direction orthogonal to the first direction on each of the surfaces 1141 and 1142. In the following, to simplify the description, when the space is divided into two by the polarizing mirror 114, the space on the side where the observer 118 is present is called a real space, and the space behind the polarizing mirror 114 as seen from the observer 118 is called an intra-mirror space. The screen 113 is placed on the floor of the real space, and the screen 115 is placed on the floor of the intra-mirror space.

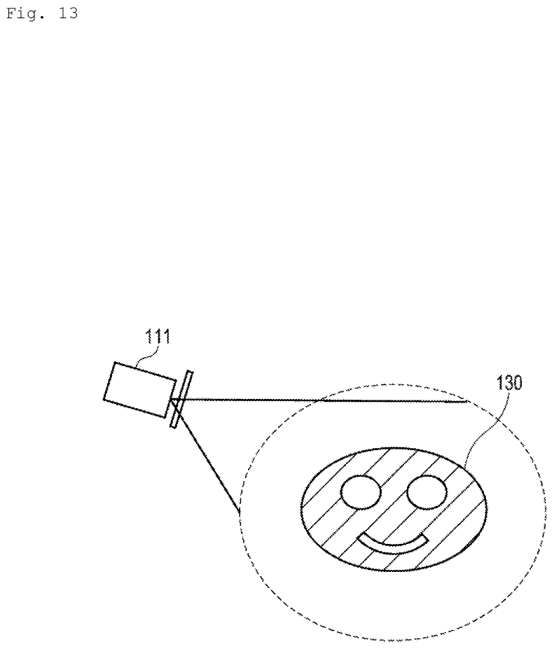

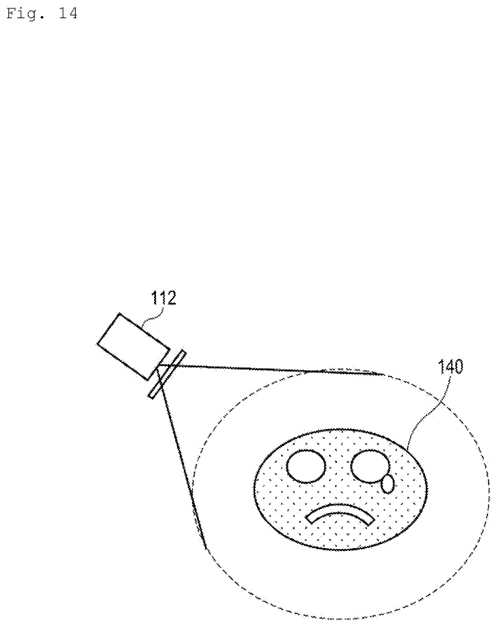

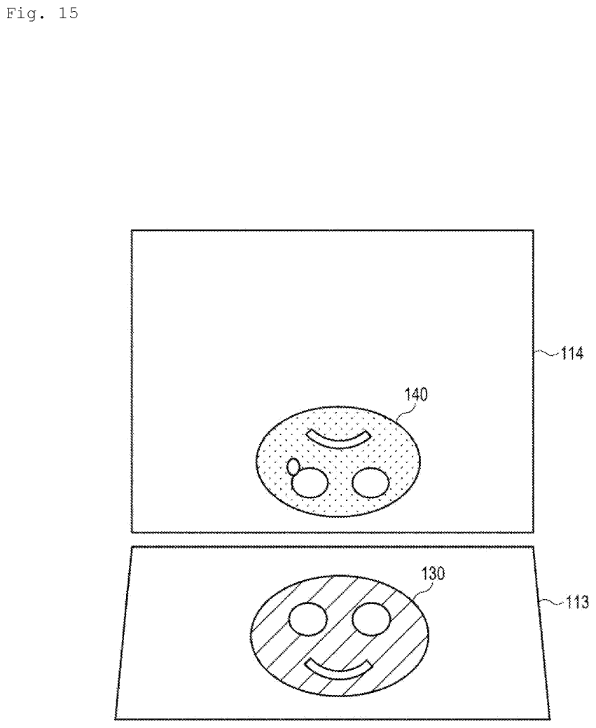

The polarized light sources 111 and 112 are disposed in the intra-mirror space and emit visual information light that is linearly polarized in the first direction. The polarized light source 111 emits visual information light toward the screen 113 via the polarizing mirror 114. Visual information light from the polarized light source 111 passes through the polarizing mirror 114 and reaches the screen 113, thereby creating a real image on the screen 113. The visual information light from the polarized light source 111 is diffusely reflected by the screen 113 while maintaining its polarization characteristics. A portion of the diffusely reflected visual information light directed toward the polarizing mirror 14 passes through the polarizing mirror 14 and is diffused in the intra-mirror space. Therefore, the visual information light from the polarized light source 11 does not create a virtual image in the intra-mirror space. Referring again to FIG. 11, the polarized light source 112 emits visual information light toward the screen 115 via the polarizing mirror 114, thereby creating a real image on the screen 115. The visual information light from the polarized light source 112 is diffusely reflected by the screen 115 while maintaining its polarization characteristics. A portion of the diffusely reflected visual information light directed toward the polarizing mirror 14 passes through the polarizing mirror 14 and reaches the observer area 119. Therefore, the real image on the screen 113 and the real image on the screen 115 are observed by the observer 118 as separate real images. When an image of the polarized light source 111 is defined as A and an image of the polarized light source 112 is defined as B, the image of A can be seen in the real space, and only the image of B can be seen in the intra-mirror space, making it possible to make the image formed by the light illuminating the real space different from the image reflected in the mirror. For example, when the polarized light source 111 projects an image 130 shown in FIG. 13 and the polarized light source 112 projects an image 140 shown in FIG. 14, As shown in FIG. 15, the image 130 is visible on the screen 113 and the image 140 is visible on the polarizing mirror 114 from the observer 118.

As described above, in the space production apparatus 110, the polarized light sources 111 and 112 and the screen 115 are disposed in the intra-mirror space and the screen 113 is disposed in the real space. The polarized light sources 111 and 112 emit light that is linearly polarized in the polarization direction transmitted by the polarizing mirror 114. The light from the polarized light source 111 is incident on the screen 113 via the polarizing mirror 114 to create a real image on the screen 113. The light emitted from the polarized light source 111 and diffusely reflected by the screen 113 is not reflected by the polarizing mirror 114 because it has polarization that is transmitted by the polarizing mirror 114. Therefore, a virtual image is not created in the intra-mirror space. The light from the polarized light source 112 is directly incident on the screen 115 and creates a real image on the screen 115. The light emitted from the polarized light source 112 and diffusely reflected by the screen 115 passes through the polarizing mirror 114 because it has polarization that is transmitted by the polarizing mirror 114. Therefore, the space production apparatus 110 can create a state in which the observer 118 can visually recognize the image derived from the polarized light source 111 in the real space (specifically, the screen 113), and can visually recognize the image derived from the polarized light source 112 reflected in the mirror (specifically, the polarizing mirror 114). That is, the space production apparatus 110 can present different images to the observer 118 in the real space and the mirror image space (the real space reflected in the mirror).

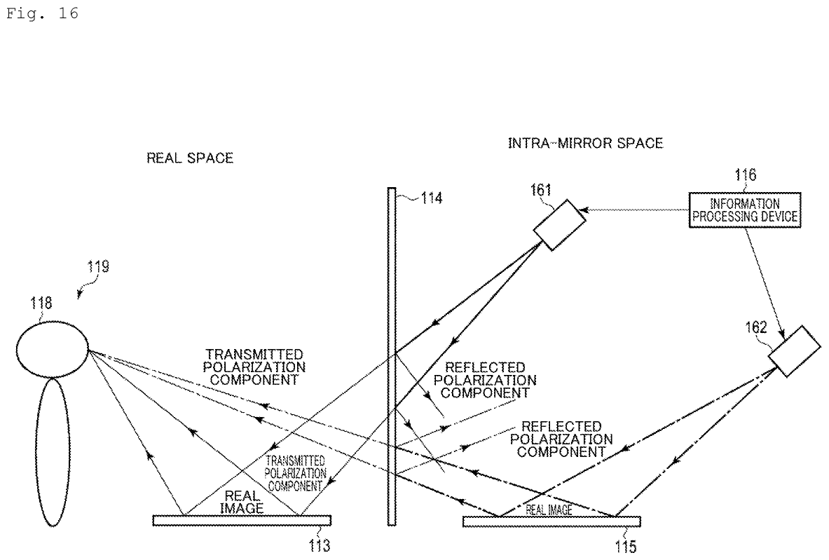

The configuration shown in FIG. 11 is only an example. For example, as shown in FIG. 16, normal light sources (non-polarized light sources) 161 and 162 may be used instead of the polarized light sources 111 and 112. In the example shown in FIG. 16, the light from each of the normal light sources 161 and 162 includes not only a component transmitting through the polarizing mirror 114 but also a component reflected by the polarizing mirror 114. There is a likelihood that the reflected component of the light from the normal light source 161 is reflected by the polarizing mirror 114 and diffusely reflected again in the intra-mirror space. There is a likelihood that the reflected component of the light from the normal light source 162 is reflected by the screen 115, then reflected by the polarizing mirror 114, and diffusely reflected again in the intra-mirror space. Since the diffusely reflected light has a component that passes through the polarizing mirror 114 as unpolarized light, there is a likelihood that the reflected components of the light from the normal light sources 161 and 162 are observed by the observer 118 as stray light in the intra-mirror space as an image that is not intended by the designer.

Furthermore, instead of the screen 115, a physical surface that diffusely reflects light, such as a general screen, may be used. In this case, the reflected light of the real image on the physical surface includes not only a transmitted component but also a reflected component. In this case as well, for the same reason as described above, there is a likelihood that the observer 118 will observe an image that is not intended by the designer.

Note that the present invention is not limited to the embodiments described above and can variously be modified at an execution stage within a scope not departing from the gist of the present invention. In addition, the embodiments may be combined as appropriate, and in such a case, combined effects can be achieved. Furthermore, the above embodiments include various inventions, and various inventions can be extracted by a combination selected from a plurality of disclosed components. For example, even if some components are deleted from all the components described in the embodiments, in a case where the problem can be solved and the effects can be obtained, a configuration from which the components are deleted can be extracted as an invention.

### REFERENCE SIGNS LIST

10 Space production apparatus
11, 12 Polarized light source
13 Screen
14 Polarizing mirror
16 Information processing device
110 Space production apparatus
111, 112 Polarized light source
113, 115 Screen
114 Polarizing mirror
116 Information processing device
161, 162 Normal light source

1. A space production apparatus comprising:
a first light source that emits first light for projecting a first image;
a second light source that emits second light for projecting a second image;
a polarizing mirror including a first surface facing an observer area where an observer is expected to be located and a second surface opposite to the first surface and configured to reflect light polarized in a first direction and transmit light polarized in a second direction orthogonal to the first direction; and
a first physical surface disposed on a side of the first surface of the polarizing mirror and configured to reflect light while maintaining polarization characteristics, at least the first image being projected onto the first physical surface.

2. The space production apparatus according to claim 1,
wherein the first light source emits the first light polarized in the first direction,
the second light source emits the second light polarized in the second direction, and
the first image and the second image are projected onto the first physical surface.

3. The space production apparatus according to claim 2,
wherein the first light source emits the first light toward the first physical surface, and
the second light source emits the second light toward the first physical surface.

4. The space production apparatus according to claim 2,
wherein the first light source emits the first light toward the first physical surface, and
the second light source emits the second light toward the second surface of the polarizing mirror such that the second light is incident on the first physical surface via the polarizing mirror.

5. The space production apparatus according to claim 1, further comprising:
a second physical surface disposed on a side of the second surface of the polarizing mirror and configured to reflect light while maintaining polarization characteristics, the second image being projected onto the second physical surface,
wherein the first light source emits the first light polarized in the second direction, and
the second light source emits the second light polarized in the second direction.

6. The space production apparatus according to claim 1, further comprising:
a second physical surface disposed on a side of the second surface of the polarizing mirror and onto which the second image is projected,
wherein the first light source emits the first light toward the second surface of the polarizing mirror such that the first light is incident on the first physical surface via the polarizing mirror, and
the second light source emits the second light toward the second physical surface.

7. A space production method comprising:
controlling a first light source that emits first light for projecting a first image;
controlling a second light source that emits second light for projecting a second image;
providing a polarizing mirror including a first surface facing an observer area where an observer is expected to be located and a second surface opposite to the first surface and configured to reflect light polarized in a first direction and transmit light polarized in a second direction orthogonal to the first direction; and
providing a first physical surface disposed on a side of the first surface of the polarizing mirror and configured to reflect light while maintaining polarization characteristics, at least the first image being projected onto the first physical surface.

8. The space production method of claim 7, further comprising:
controlling the first light source that emits the first light polarized in the first direction;
controlling the second light source that emits the second light polarized in the second direction; and
wherein the first image and the second image are projected onto the first physical surface.

9. The space production method of claim 8, further comprising:
controlling the first light source that emits the first light toward the first physical surface; and
controlling the second light source that emits the second light toward the first physical surface.

10. The space production method of claim 8, further comprising:
controlling the first light source that emits the first light toward the first physical surface, and
controlling the second light source that emits the second light toward the second surface of the polarizing mirror such that the second light is incident on the first physical surface via the polarizing mirror.

11. The space production method of claim 7, further comprising:
a second physical surface disposed on a side of the second surface of the polarizing mirror and configured to reflect light while maintaining polarization characteristics, the second image being projected onto the second physical surface;
controlling the first light source that emits the first light polarized in the second direction; and
controlling the second light source that emits the second light polarized in the second direction.

12. The space production method of claim 7, further comprising:
a second physical surface disposed on a side of the second surface of the polarizing mirror and onto which the second image is projected;
controlling the first light source that emits the first light toward the second surface of the polarizing mirror such that the first light is incident on the first physical surface via the polarizing mirror; and
controlling the second light source that emits the second light toward the second physical surface.
